(19) United States
(12) Patent Application Publication
(10) Pub. No.: US 2024/0430752 A1
(43) Pub. Date: Dec. 26, 2024

(54) DATA ANALYSIS METHODS AND APPARATUSES OF RADIO NETWORK, COMMUNICATION DEVICES AND STORAGE MEDIUMS

(71) Applicants: Beijing Xiaomi Mobile Software Co., Ltd., Beijing (CN); Beijing University of Posts and Telecommunications, Beijing (CN)

(72) Inventors: Qin MU, Beijing (CN); Wei HONG, Beijing (CN); Zhongyuan ZHAO, Beijing (CN); Kexin XIONG, Beijing (CN); Yuqiang CHEN, Beijing (CN)

(73) Assignees: Beijing Xiaomi Mobile Software Co., Ltd., Beijing (CN); Beijing University of Posts and Telecommunications, Beijing (CN)

(21) Appl. No.: 18/273,934

(22) PCT Filed: Jan. 27, 2021
(86) PCT No.: PCT/CN2021/073994

§ 371 Date: Jul. 24, 2023

(51) Int. Cl. H04W 28/24; H04W 24/02

(52) U.S. Cl. CPC H04W 28/24; H04W 24/02

(57) ABSTRACT

A data analysis method of a radio network is applied to a first-level NWDAF network element and includes: according to a to-be-performed first-class analysis, obtaining a second-level analysis report sent by a second-level NWDAF network element in correspondence with a network slice to which a target user equipment (UE) belongs; according to the second-level analysis report, sending a first-level analysis report to an NWDAF user, where the NWDAF user is configured to adjust network parameters of the first-class analysis according to the first-level analysis report.

### CROSS-REFERENCE TO RELATED APPLICATION

This application is a National Phase of International Application No. PCT/CN2021/073994, filed on Jan. 27, 2021, the entire contents of which are incorporated herein by reference in their entireties.

### TECHNICAL FIELD

The present disclosure relates to the radio communication field but is not limited to the radio communication field, and in particular to data analysis methods and apparatuses of a radio network, communication devices and storage mediums.

### BACKGROUND

In many new service scenarios of fifth generation mobile communication network technology (5G), differentiated requirements for service level agreement (SLA) are proposed, which brings complexity to network operation. In the face of complex communication scenarios, diversified service requirements and individualized service experiences in the future, the intelligence level of the current 5G network is still insufficient to realize on-demand service and higher network resource utilization rate.

### SUMMARY

The present disclosure provides a data analysis method and apparatus for a radio network, a communication device and a storage medium.

According to a first aspect of embodiments of the present disclosure, there is provided a data analysis method of a radio network, which is applied to a first-level Network Data Analytics Function (NWDAF) network element and includes: according to a to-be-performed first-class analysis, obtaining a second-level analysis report sent by a second-level NWDAF network element in correspondence with a network slice to which a target user equipment (UE) belongs; and according to the second-level analysis report, sending a first-level analysis report to an NWDAF user, where the NWDAF user is configured to adjust network parameters of the first-class analysis according to the first-level analysis report.

According to a second aspect of embodiments of the present disclosure, there is provided a data analysis method of a radio network, which is applied to a second-level NWDAF network element and includes: according to a to-be-performed first-class analysis, sending a second-level analysis report to a first-level NWDAF network element, where the second-level NWDAF network element is in correspondence with a network slice to which a target user equipment (UE) corresponding to the first-class analysis belongs, the first-level NWDAF network element is configured to, according to the second-level analysis report, send a first-level analysis report to an NWDAF user, the NWDAF user is configured to adjust network parameters of the first-class analysis based on the first-level analysis report.

According to a third aspect of embodiments of the present disclosure, there is provided a communication device, where the communication device at least includes: a processor; and a memory storing instructions executable by the processor, where the processor is configured to, when executing the instructions, perform the steps of any one of the above data analysis methods of the radio network.

### BRIEF DESCRIPTION OF THE DRAWINGS

The accompanying drawings, which are incorporated in and constitute a part of the present description, illustrate examples consistent with the present disclosure and serve to explain the principles of the present disclosure together with the description.

FIG. 1 is a structural schematic diagram illustrating a radio communication system according to an exemplary embodiment of the present disclosure.

FIG. 2 is a flowchart illustrating a data analysis method according to an exemplary embodiment of the present disclosure.

FIG. 3 is a flowchart illustrating a data analysis method according to an exemplary embodiment of the present disclosure.

FIG. 4 is a flowchart illustrating a data analysis method according to an exemplary embodiment of the present disclosure.

FIG. 5 is a flowchart illustrating a data analysis method according to an exemplary embodiment of the present disclosure.

FIG. 6 is a flowchart illustrating a data analysis method according to an exemplary embodiment of the present disclosure.

FIG. 7 is an architecture diagram illustrating a data analysis system according to an exemplary embodiment of the present disclosure.

FIG. 8 is a flowchart illustrating a data analysis method according to an exemplary embodiment of the present disclosure.

FIG. 9 is a flowchart illustrating collection and association of network data in a data analysis method according to an exemplary embodiment of the present disclosure.

FIG. 10 is a schematic diagram illustrating data association identifiers in a data analysis method according to an exemplary embodiment of the present disclosure.

FIG. 11 is a principle diagram of a protocol and an interface for registration and subscription in a data analysis method according to an exemplary embodiment of the present disclosure.

FIG. 12 is a principle diagram of a protocol and an interface for data collection and association in a data analysis method according to an exemplary embodiment of the present disclosure.

FIG. 13 is a principle diagram of a protocol and an interface for self analysis and result feedback in a data analysis method according to an exemplary embodiment of the present disclosure.

FIG. 14 is a structural block diagram illustrating a data analysis apparatus according to an exemplary embodiment of the present disclosure.

FIG. 15 is a structural block diagram illustrating a data analysis apparatus according to an exemplary embodiment of the present disclosure.

FIG. 16 is a structural schematic diagram illustrating a communication device according to an exemplary embodiment of the present disclosure.

FIG. 17 is a structural schematic diagram illustrating a communication device according to an exemplary embodiment of the present disclosure.

### DETAILED DESCRIPTION OF THE EMBODIMENTS

Exemplary embodiments will be described in detail herein, with the illustrations thereof represented in the drawings. When the following descriptions involve the drawings, like numerals in different drawings refer to like or similar elements unless otherwise indicated. The embodiments described in the following examples do not represent all embodiments consistent with the present disclosure. Rather, they are merely examples of apparatuses and methods consistent with some aspects of the present disclosure as detailed in the appended claims.

The terms used in the present disclosure are for the purpose of describing particular examples only, and are not intended to limit the present disclosure. The terms “a”, “the” and “said” in their singular forms in the present disclosure and the appended claims are also intended to include plurality, unless clearly indicated otherwise in the context. It should also be understood that the term “and/or” as used herein refers to and includes any or all possible combinations of one or more of the associated listed items.

It is to be understood that, although the terms “first,” “second,” “third,” and the like may be used in the present disclosure to describe various information, such information should not be limited to these terms. These terms are only used to distinguish one category of information from another. For example, without departing from the scope of the present disclosure, first information may be referred as second information; and similarly, the second information may also be referred as the first information. Depending on the context, the term “if” as used herein may be interpreted as “when” or “upon” or “in response to determining”.

In order to describe any one embodiment of the present disclosure better, descriptions are made to one embodiment of the present disclosure with an application scenario of one access control as an example.

FIG. 1 is a structural schematic diagram illustrating a radio communication system according to an embodiment of the present disclosure. As shown in FIG. 1, the radio communication system is a communication system based on cellular mobile communication technology and may include a plurality of terminals 11 and a plurality of base stations 12.

The terminal 11 may be a device directed toward a user to provide voice and/or data connectivity. The terminal 11 may communicate with one or more core networks through a radio access network (RAN). The terminal 11 may be a terminal of internet of things, such as a sensor device, a mobile phone, (or called cellular phone), and a computer having a terminal of internet of things, such as a fixed, portable, pocket-sized, handheld, or computer-inbuilt or vehicle-mounted apparatus, such as station (STA), subscriber unit, subscriber station, mobile station, mobile, remote station, access point, remote terminal, access terminal, user terminal, user agent, user device, or user equipment. Alternatively, the terminal 11 may also be a device of an unmanned aerial vehicle, or a vehicle-mounted device, for example, may be a trip computer having wireless communication function, or a wireless terminal externally connected to a trip computer. Alternatively, the terminal 11 may be a roadside device, for example, may be a road lamp, signal lamp or another roadside device having wireless communication function.

The base station 12 may be a network side device in a radio communication system. The radio communication system may be a fourth-generation mobile communication technology (4G) system, which is also called long term evolution (LTE) system. Alternatively, the radio communication system may also be a 5G system, which is also called new radio (NR) system or 5G NR system. Alternatively, the radio communication system may also be a next generation system of the 5G system. An access network in the 5G system may be referred to as new generation-radio access network (NG-RAN).

The base station 12 may be an evolved base station (eNB) employed in the 4G system. Alternatively, the base station 12 may also be a base station adopting centralized distributed architecture (gNB) in the 5G system. When adopting the centralized distributed architecture, the base station 12 usually includes a central unit (CU) and at least two distributed units (DU). In the central unit, protocol stacks of a packet data convergence protocol (PDCP) layer, a radio link control (RLC) layer and a media access control (MAC) layer are disposed; in the distributed unit, a physical (PHY) layer protocol stack is disposed. The specific implementations of the base station 12 are not limited in the embodiments of the present disclosure.

Wireless connection may be established between the base station 12 and the terminal 11 through a wireless air interface. In different implementations, the wireless air interface is a wireless air interface based on the fourth generation mobile communication network technology (4G) standard; or, the wireless air interface is a wireless air interface based on the fifth generation mobile communication network technology (5G) standard, for example, the wireless air interface is a new air interface; or, the wireless air interface may also be a wireless air interface based on a next generation mobile communication network technology standard of 5G.

In some embodiments, end to end (E2E) connection may also be established between the terminals 11, for example, in the scenarios of vehicle to vehicle (V2V) communication, vehicle to infrastructure (V2I) communication, and vehicle to pedestrian (V2P) communication and the like in vehicle to everything (V2X) communication.

In some embodiments, the above radio communication system may further include a network management device 13.

A plurality of base stations 12 are connected to the network management device 13 respectively. The network management device 13 may be a core network device in the radio communication system. For example, the network management device 13 may be a mobility management entity (MME) in an evolved packet core (EPC). Alternatively, the network management device may also be another core network device, such as serving gateway (SGW), public data network gateway (PGW), policy and charging rules function (PCRF), or home subscriber server (HSS). The implementation morphology of the network management device 13 is not limited in the embodiments of the present disclosure.

In order to increase the network resource utilization rate, NWDAF network elements are introduced to assist the network slice in load analysis, so as to optimize the selection and 5G quality of service (QOS) decision of the network slice. Furthermore, the 5G intelligent network architecture and capability, and the data analysis results derived by the NWDAF under different scenarios are all to be regulated, and the NWDAF functions are also to be supplemented and enhanced.

The design of the future network architecture aims to achieve hierarchical intelligent network architecture, provide platform-based capability, satisfy the deployment requirements of large operator and network, and enable vertical service expansion.

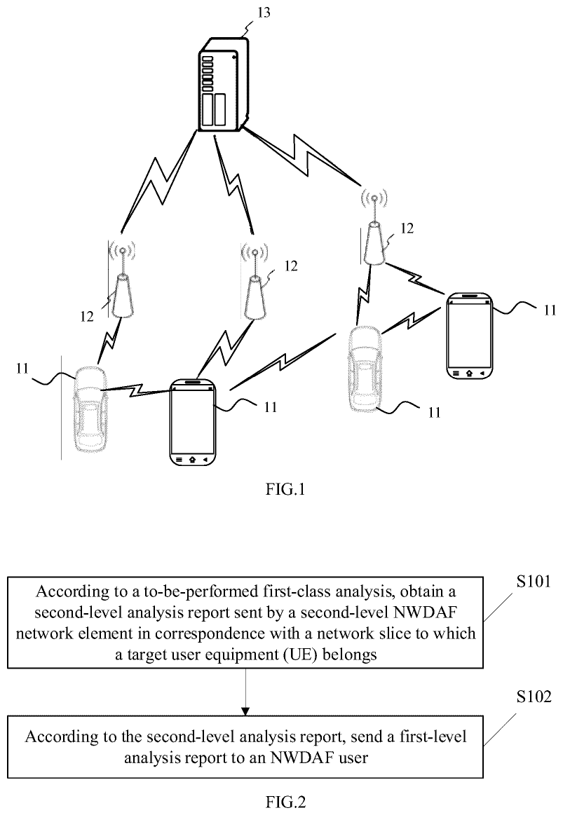

As shown in FIG. 2, an embodiment of the present disclosure provides a data analysis method of a radio network according to an embodiment of the present disclosure. The method is applied to a first-level NWDAF network element, and includes the following steps S101 to S102.

At step S101, according to a to-be-performed first-class analysis, a second-level analysis report sent by a second-level NWDAF network element in correspondence with a network slice to which a target user equipment (UE) belongs is obtained.

At step S102, according to the second-level analysis report, a first-level analysis report is sent to an NWDAF user, where the NWDAF user is configured to adjust network parameters of the first-class analysis according to the first-level analysis report.

The NWDAF is a data perception and analysis network element, which, based on network data, performs automatic perception and analysis on a network and participates in a full life cycle of network planning, construction, operation and maintenance, network optimization and operation. In this way, the network is easily maintained and controlled, and the network resource utilization rate can be increased, and further, the use experience of the users is improved. The NWDAF can collect raw data from network function (NF), application function (AF) and operation administration and maintenance (OAM), and perform smart analysis on the raw data, and then feed an analysis result back to the NF, the AF and the OAM and the like for the purpose of network and service optimization. In a NWDAF working cycle, the efficiency of the data collection, and the fusion manner of different dimensions of data and the like have great impact on the analysis and feedback efficiency, intelligent network operation, and the service performance. Therefore, in the embodiments of the present disclosure, an efficiency data collection and association method is achieved by using the NWDAF.

In the embodiments of the present disclosure, a two-level hierarchical NWDAF architecture is deployed and works such as radio network data collection and association, analysis and subscription and result feedback are carried out on the architecture. In the embodiments of the present disclosure, the first-level NWDAF network element serves shared network elements of a plurality of network slices, the second-level NWDAF network element serves a monopolized network element of a single network slice, and a plurality of second-level NWDAF network elements serve a monopolized network function of a same network slice.

Herein, the network slice is an on-demand networking manner which allows the operator to separate out a plurality of virtual end-to-end networks on a unified infrastructure. Each of the network slices performs logical isolation from radio access network to a bearer network and then to a core network, so as to adapt to various types of services.

In the embodiments of the present disclosure, an NWDAF user, i.e., an NWDAF service consumer, proposes a requirement for data analysis, namely, the first-class analysis to be performed for the target UE. Thus, the first-level NWDAF network element and the second-level NWDAF network element perform data collection and analysis based on the to-be-performed first-class analysis, and generate a corresponding analysis report. The NWDAF user performs corresponding network parameter adjustment based on the analysis report, so as to achieve network optimization.

The NWDAF network element that the NWDAF user subscribes to is the first-level NWDAF network element, and therefore, the first-level NWDAF network element sends the first-level analysis report to the NWDAF user. The first-level NWDAF network element subscribes to the second-level NWDAF network element, and therefore, the second-level NWDAF network element sends the obtained second-level analysis report to the first-level NWDAF network element, and the first-level NWDAF network element performs further processing on the second-level analysis report to generate the final first-level analysis report.

In the embodiments of the present disclosure, since the second-level NWDAF network element is an NWDAF network in correspondence with the network slice, the second-level NWDAF network element has monopoly over the data of the network slice. The second-level NWDAF network element collects monopolized data in the network slice and performs corresponding analysis and generates a corresponding second-level analysis report. In this process, it is not required to perform data exchange between network slices. The first-level NWDAF network element can perform collection and analysis on shared data between a plurality of network slices.

Thus, compared with the division of the second-level NWDAF network elements based on service area, in the embodiments of the present disclosure, data analysis is performed by the first and second-level NWDAF network elements, where the second-level NWDAF network element is in correspondence with the network slice. In this way, on one hand, isolation requirement for the network elements between the network slices can be fulfilled to increase data security and on the other hand, the division of the second-level NWDAF network elements based on network slice is more applicable to a scenario where a mobile terminal switches between different service areas, so as to reduce the NWDAF service interruptions resulting from switching of the terminal between service areas. Thus, improving the use experiences of the users.

Furthermore, compared with the fact that one or more second-level NWDAF network elements are responsible for one service area, the problem of diversity and unbalance may occur to the data analysis requirement in the service area, and thus it is required to deploy a plurality of NWDAFs supporting different analysis types in one service area. In the embodiments of the present disclosure, divided based on network slice, each second-level NWDAF network element is responsible for the monopolized NFs of one network slice. Hence, a smaller number of NWDAFs are deployed in a plurality of service areas, which reduces deployment cost and increases use efficiency.

In some embodiments, the second-level NWDAF network element serves an independent network slice and is configured to analyze at least one network function (NF) monopolized by the network slice.

In one or more embodiments of the present disclosure, the second-level NWDAF network element is used only to serve the independent network slice and can perform collection and analysis and the like on the data of one or more NFs in the served independent network slice. Thus, each independent network slice may correspond to one or more second-level NWDAF network elements.

Processing on the to-be-performed first-class analysis can be performed by using the second-level NWDAF network element supporting the analysis.

In this case, isolation on the second-level NWDAF network element is achieved on the network slice, which improves security of data between network slices and service independence, and reduces potential hazard of the data security.

In some embodiments, the second-level NWDAF network element includes at least one of: a first-class network element configured to perform the first-class analysis to obtain the second-level analysis report; or a second-class network element configured to, based on an analysis report sent by an auxiliary NWDAF network element, perform analysis to obtain the second-level analysis report.

The second-level NWDAF network element can perform analysis on the collected data, that is, perform the above first-class analysis on the collected data to obtain the corresponding second-level analysis report. Furthermore, data exchange may be performed between the second-level NWDAF network elements, namely, the auxiliary NWDAF network element is also a second-level NWDAF network element used to assist another second-level network element in data analysis.

In some embodiments, the first-class network element is configured to collect data corresponding to the first-class analysis and based on the data corresponding to the first-class analysis, perform the first-class analysis.

The second-class network element is configured to collect the data corresponding to the first-class analysis and data provided by the auxiliary NWDAF network element and perform the first-class analysis. The auxiliary NWDAF network element is configured to collect data corresponding to a second-class analysis, and based on the data corresponding to the second-class analysis, perform the second-class analysis to obtain the second-level analysis report. Where the second-class analysis is an associated analysis of the first-class analysis.

The above second-class network element can receive the analysis report sent by the auxiliary NWDAF network element. The analysis report sent by the auxiliary NWDAF network element may be an analysis report obtained by performing the second-class analysis different from the first-class analysis. The analysis report may be used to assist the second-class network element in performing the first-class analysis to obtain the second-level analysis report sent to the first-class network element.

Namely, the data obtained by the auxiliary NWDAF network element by performing the second-class analysis can assist the second-level NWDAF network element in performing the first-class analysis. Thus, the second-level NWDAF network element prepares the analysis report with the assistance of the auxiliary NWDAF network element.

The data of the target UE corresponding to an NF in a same network slice is analyzed by using the first-class network element; and the related data of the target UE between different NFs or different network slices may be analyzed by using the second-class network element such that comprehensive analysis of the data between different NFs or different network slices can be achieved.

An embodiment of the present disclosure provides a data analysis method, which, as shown in FIG. 3, includes the following steps S201 to S202.

At step S201, based on the first-class analysis, to-be-analyzed shared data is obtained from a shared network element.

At step S202, based on the shared data and the second-level analysis report, the first-level analysis report is sent to the NWDAF user.

In the embodiments of the present disclosure, the first-level NWDAF network element is used to perform data analysis on the shared network element. Thus, data can be obtained from the shared network element based on the to-be-performed first-class analysis. The data can be shared data.

Furthermore, the first-level NWDAF network element also needs to obtain from the second-level NWDAF network element an analysis report which is the second-level analysis report obtained by each second-level NWDAF network element (one or more network elements) by performing analysis on the monopolized data or the like of their respective network slices.

As a result, the first-level NWDAF network element may, based on the shared data and the second-level analysis report, obtain a complete first-level analysis report for the to-be-performed first-class analysis and then report the first-level analysis report to the NWDAF user, thus satisfying the analysis requirements.

In some embodiments, the shared network element includes at least one of: a shared network function (NF); an internal application function (AF); a third party AF; operation administration and maintenance (OAM); or a network exposure function (NEF).

The AF refers to various services of an application layer, which may be applications inside an operator or services such as video service and game service provided by a third party.

The shared NFs refer to various network functions shared between network slices.

The OAM refers to the operation administration and maintenance function of a network, which is realized based on the actual requirements of the network operation of the operator to complete analysis, prediction, planning and configuration of the daily network and service, and the operations such as service test and failure management and the like.

The NEF refers to a network exposure function located between a core network and an external third party application function to manage open network data, including QoS custom capability opening of an external application, mobility state event subscription, and AF request distribution and the like. The external application accesses the internal data of the core network through NEF.

In some embodiments, the second-level NWDAF network element is configured to obtain monopolized NF data and based on the monopolized NF data, send the second-level analysis report to the first-level NWDAF network element.

In the embodiments of the present disclosure, since the second-level NWDAF network element only serves one network slice, the second-level NWDAF network element is used to obtain the monopolized NF data in the network slice and generate the corresponding second-level analysis report. Since the first-level NWDAF network element subscribes to the second-level NWDAF network element, the second-level analysis report, after being sent to the first-level NWDAF network element, is further processed by the first-level NWDAF network element.

In some embodiments, the monopolized NF data and the shared data obtained by the first-level NWDAF network element from the shared network element both carry data association identifiers which are used to identify an association relationship between each piece of data and the target UE.

The service data of a same user equipment may include various shared data and the monopolized NF data. Thus, during an analysis, it is required to associate with the service data corresponding to the user equipment to facilitate obtaining an overall analysis result. The data association identifiers for association with the target UE are present in the shared data and the monopolized NF data corresponding to the above to-be-performed first-class analysis.

The first-level NWDAF network element may, based on the collected shared data and the second-level analysis report about the monopolized NF data reported by the second-level NWDAF network element, perform unified analysis on the data associated with the target UE and generate the corresponding first-level analysis report.

In some embodiments, the data association identifiers include at least one of: an internet protocol (IP) address of the target UE; IP quintuple; timestamp; Subscription Permanent Identifier (SUPI); Data Network Name (DNN); Single Network Slice Selection Assistance Information (S-NSSAI); application protocol identifier of user equipment NG interface (interface between access network and 5G core network) of a radio access network; and Access Network (AN) tunnel information.

The NWDAF network element may collect data from each shared data network element or the monopolized data network element and the data of a same user is usually distributed on different network elements. Thus, in order to obtain end-to-end data of the user, it is required to associate, by using the data association identifiers, the data collected from the network elements.

In the embodiments of the present disclosure, the network elements providing data include but not limited to: Session Management Function (SMF), User plane Function (UPF), Access and Mobility Management Function (AMF), Policy Control function (PCF), Application Function (AF), and Operation Administration and Maintenance (OAM) and the like.

The SMF refers to a Session Management Function network element, and the SMF data mainly include session information. The UPF refers to a User Plane Function network element, and the UPF data mainly includes flow information. The AMF refers to an Access and Mobility Management Function network element and the AMF data mainly includes user position information. The PCF refers to a Policy Control Function network element, and the PCF data mainly includes policy information; the AF refers to an Application Function network element and the AF data mainly includes service information. The OAM refers to an Operation Administration and Maintenance network element and the OAM data from the RAN side mainly includes radio channel information.

In the embodiments of the present disclosure, association of the data of the network elements by using a data association identifier may be performed by using one or two or more of the IP address of the target UE, the IP quintuple, the timestamp, the SUPI, the DNN, the S-NSSAI, the application protocol identifier of user equipment NG interface of the radio access network; and the AN tunnel information. For example, the association may be performed by using the IP address of the terminal and the timestamp, or by using the IP quintuple or by using the SPUI and the timestamp or the like.

For the above network elements, an embodiment of the present disclosure provides the following exemplary association method.
1. The SMF data and the UPF data may be associated by using the IP address of the target UE and the timestamp.
2. The UPF data and the AF data may be associated by using the IP quintuple and the timestamp.
3. The SMF data and the AMF data may be associated by using the SUPI and the timestamp.
4. The SMF data and the PCF data may be associated by using the SUPI, the DNN, the S-NSSAI or the IP address of the target UE.
5. The AMF data and the OAM data may be associated by using the RAN UE NGAP ID and the timestamp.
6. The UPF data and the OAM data may be associated by using the AN tunnel information and the timestamp.
7. The SMF data and the AF data may be associated by using the application ID, the IP filtering information and the timestamp.

The IP quintuple includes a source IP address, a source port, a destination IP address, a destination port and a transport layer protocol. The SUPI is a unique permanent identifier of a user in the 5G network. The DNN is a data network name. The S-NSSAI is a unique identifier of a network slice. The RAN UE NGAP ID is an application protocol identifier of user equipment NG interface of a radio access network, where the RAN UE NGAP ID is unique in the NG-RAN node. The AN tunnel information includes endpoint IP address and GTP tunnel endpoint identifier.

In some embodiments, the second-level NWDAF network element is further configured to receive desensitized monopolized NF data from the auxiliary NWDAF network element. Where the auxiliary NWDAF network element is configured to perform desensitization on the obtained monopolized NF data and send the desensitized monopolized NF data to the second-level NWDAF network element.

In the embodiments of the present disclosure, it is possible for the second-level NWDAF network element to perform data analysis with the assistance of the auxiliary NWDAF network element. Thus, the second-level NWDAF network element may receive the monopolized NF data sent by the auxiliary NWDAF network element. After collecting the corresponding monopolized NF data, in order to reduce the possibility of lower security resulting from data exchange between network slices, the auxiliary NWDAF network element needs to perform desensitization on the data, for example, remove sensitive information in the monopolized NF data or perform proper encryption on the data or the like.

After the second-level NWDAF network element receives the data provided by the auxiliary NWDAF network element, the second-level NWDAF network element may perform comprehensive processing in combination with the monopolized NF data collected by itself, so as to obtain the corresponding second-level analysis report.

An embodiment of the present disclosure provides a data analysis method, which, as shown in FIG. 4, is applied to the first-level NWDAF network element and includes the following steps S301 to S302.

At step S301, a first request of the NWDAF user is received.

At step S302, according to the first request, a second-level NWDAF network element for obtaining the second-level analysis report is determined.

In one or more embodiments of the present disclosure, the NWDAF user subscribes to the first-level NWDAF network element, and the first-level NWDAF network element, based on an analysis requirement of the NWDAF user, obtains corresponding shared data and provides a corresponding analysis report to the NWDAF user.

Furthermore, the first-level NWDAF network element may, based on the first request of the NWDAF user, determine the second-level NWDAF network element needing to perform corresponding data analysis and thus can obtain the second-level analysis report from the second-level NWDAF network element. Then based on the second-level analysis report and the shared data, obtain the first-level analysis report desired by the NWDAF user.

In some embodiments, based on the first request, determining the second-level NWDAF network element configured to obtain the second-level analysis report includes: based on the first request, obtaining a network element identifier of the second-level NWDAF network element from the UDM.

The first-level NWDAF network element may determine, by inquiring the UDM, the monopolized NF of the network slice to which the target UE belongs. Thus, the first-level NWDAF network element may obtain the network element identifier of the second-level NWDAF network element from the UDM and then determine the second-level NWDAD network element or second-level NWDAD network elements from which the corresponding second-level analysis report is obtained.

It is to be noted that, for a network slice with partial shared network element mode, the first-level NWDAF network element performs collection and analysis on the shared data of the shared network element in the network slice, and the second-level NWDAF network element is configured to obtain and analyze the data of the monopolized network element in the network slice. Meanwhile, the first-level NWDAF network element is further configured to obtain the analysis report of the second-level NWDAF network element.

Illustratively, the network slices share the AMF, the UDM and the PCF and the like, and each network slice has the monopolized UPF and SMF network elements. Thus, each second-level NWDAF network element serves the monopolized NF of one network slice. For example, the target UE belongs to the network slice 1 and thus the monopolized NFs serving it are UPF1 and SMF1.

For a network slice with a full shared network element mode, the first-level NWDAF network element may perform data collection and processing on all the network elements in the network slice. At this time, it is not required to use the second-level NWDAF network element for the network slice.

For a network slice with a full monopolized network element mode, the network elements in the network slice are fully independent and thus, the data in the network slice is to be collected and processed by the second-level NWDAF network element. At this time, for the first-level NWDAF network element, no data to be processed for the network slice is present.

In some embodiments, the first request includes at least one of: identifier information of the first-class analysis; identifier information of the target UE; or identifier information of the second-class analysis associated with the first-class analysis.

In the embodiments of the present disclosure, the NWDAF user subscribes to the first-level NWDAF network element. The first request may include relevant identifier information of the to-be-performed first-class analysis. Thus, the first-level NWDAF network element may determine the to-be-performed first-class analysis and to-be-collected data and the like based on the identifier information.

Moreover, the first request may further include the identifier information of the target UE such that the first-level NWDAF network element can perform data collection for the target UE so as to finally obtain the analysis report of the target UE based on the first-class analysis.

For the above first-class analysis, an associated second-class analysis may be further included. The second-class analysis may be performed by the first-level NWDAF network element or the second-level NWDAF network element. The first request includes identifier information of the second-class analysis, and the first-level NWDAF network element may, based on the identifier information, determine the second-class analysis is performed by itself or by the corresponding second-level NWDAF network element.

Therefore, the first-level NWDAF network element may determine each analysis to be performed based on the first request, so as to jointly complete data collection and analysis and processing with the relevant second-level NWDAF network element and obtain the first-level analysis report desired by the NWDAF user.

In some embodiments, based on the first request, obtaining the network element identifier of the second-level NWDAF network element from the UDM includes: based on the first request, determining, from the UDM, information of the monopolized NF of the network slice to which the target UE belongs; and based on the information of the monopolized NF, determining the network element identifier of the second-level NWDAF network element serving the network slice to which the target UE belongs from the second-level NWDAF network elements registered in the NRF network element.

In the embodiments of the present disclosure, the first-level NWDAF network element and the second-level NWDAF network element are both registered in the NRF, and the first-level NWDAF network element may obtain the corresponding second-level analysis report from the second-level NWDAF network elements registered in the NRF. Thus, the first-level NWDAF network element may determine, based on the first request, the information of the monopolized NF of the network slice to which the target UE belongs, namely, determine the monopolized NF or NFs the data of which is to be analyzed. In this case, the first-level NWDAF network element may determine the corresponding second-level NWDAF network element from the second-level NWDAF network elements registered in the NRF to perform the corresponding data collection and analysis processing.

An embodiment of the present disclosure further provides a data analysis method, which, as shown in FIG. 5, is applied to the first-level NWDAF network element and includes the following step S401.

At step S401, according to the network element identifier of the second-level NWDAF network element, a second request is sent to the second-level NWDAF network element, where the second request is used by the second-level NWDAF network element to report analysis data.

The first-level NWDAF network element may subscribe to the second-level NWDAF network element needing to obtain the corresponding data. Thus, the first-level NWDAF network element may, based on the network element identifier of the second-level NWDAF network element determined from the NRF, send the second request to the second-level NWDAF network element so as to subscribe to the analysis report of the second-level NWDAF network element.

In some embodiments, the second request includes at least one of: identifier information of the first-class analysis; identifier information of the target UE; or identifier information of the second-class analysis associated with the first-class analysis.

The second request has the similar functions to the first request, that is, is used to notify the second-level NWDAF network element of the to-be-performed first-class analysis and/or the second-class analysis associated with the first-class analysis and the target UE to perform analysis and the like. Thus, the second-level NWDAF network element can perform the corresponding analysis based on the second request and provide the analysis report to the first-level NWDAF network element.

In some embodiments, the second-level NWDAF network element is further configured to send a third request to the auxiliary NWDAF network element, where the third request includes at least one of: identifier information of the target UE; or identifier information of the second-class analysis associated with the first-class analysis.

One second-level NWDAF network element only serves the monopolized NFs of one network slice, and the analysis report desired by the NWDAF user may be generated by performing associated analysis on the data of a plurality of network slices. Therefore, some second-level NWDAF network elements may obtain the associated data analysis reports with the assistance of the auxiliary NWDAF network element.

Hence, the second-level NWDAF network element may obtain the corresponding data analysis report by sending the third request to the auxiliary NWDAF network element.

Since the auxiliary NWDAF network element subscribed to by the second-level NWDAF network element does not need to perform the first-class analysis but the second-class analysis associated the first-class analysis, the third request may include information associated with performing analysis by the auxiliary NWDAF network element. Specifically, including the identifier information of the target UE and the identifier information of the second-class analysis and the like.

In some embodiments, the first request may be a request sent by the NWDAF user to the first-level NWDAF network element registered in the NRF.

In the embodiments of the present disclosure, the first-level NWDAF network element and the second-level NWDAF network element may be registered in the NRF network element. When the NWDAF user obtains an analysis report of the target UE about the first-class analysis, the NWDAF user may determine network elements for performing the first-class analysis and the associated second-class analysis from various levels of NWDAF network elements registered in the NRF network element.

In one embodiment, the NWDAF user may send an analysis request to the NRF network element, and obtain an analysis request response from the NRF network element. The NWDAF user may, based on the analysis response, determine the first-level NWDAF network element and the second-level NWDAF network element for performing analysis, and further send the first request to the first-level NWDAF network element to subscribe to the first-level NWDAF network element.

In some embodiments, the NRF is used to receive an analysis request sent by the NWDAF user, and based on the analysis request, send an analysis request response to the NWDAF user. The analysis request includes the identifier information of the first-class analysis; the analysis request response is used for the NWDAF user to determine to send the first request to the first-level NWDAF network element.

In the embodiments of the present disclosure, the NRF is a network repository function used to perform NF registration, management, state detection and achieve automatic management over all the NFs. When each NF is enabled, the NF must be registered in the NRF to provide services, where the registration information includes NF type, address and service list and the like.

In the embodiments of the present disclosure, the NWDAF user may send an analysis request to the NRF and the NRF sends an analysis request response to provide information about the NWDAF network elements capable of performing analysis. Thus, the NWDAF user sends a corresponding subscription request to the NRF to subscribe to the NWDAF network elements capable of providing the desired analysis report.

In some embodiments, the NWDAF network elements registered in the NRF at least include: the first-level NWDAF network element and the second-level NWDAF network element. The first-level NWDAF network element and the second-level NWDAF network element may be registered in the NRF, such that the NRF can perform an analysis request response based on the registered NWDAF network elements upon receiving an analysis request.

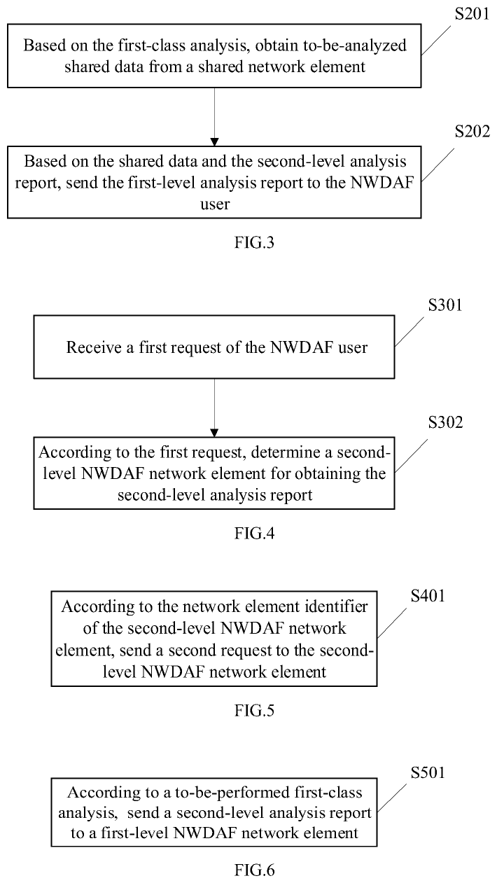

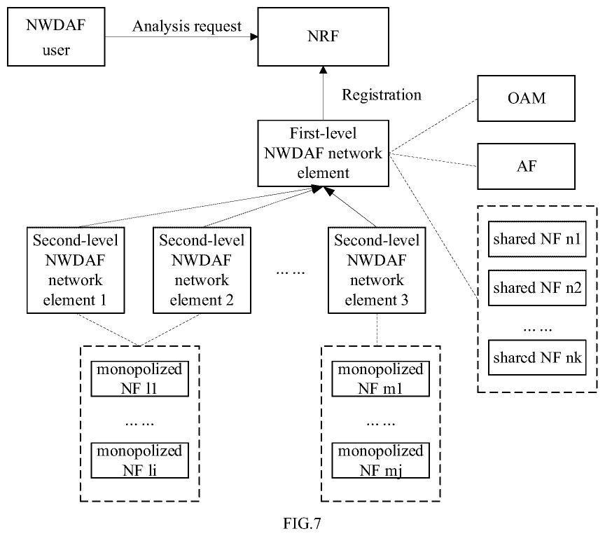

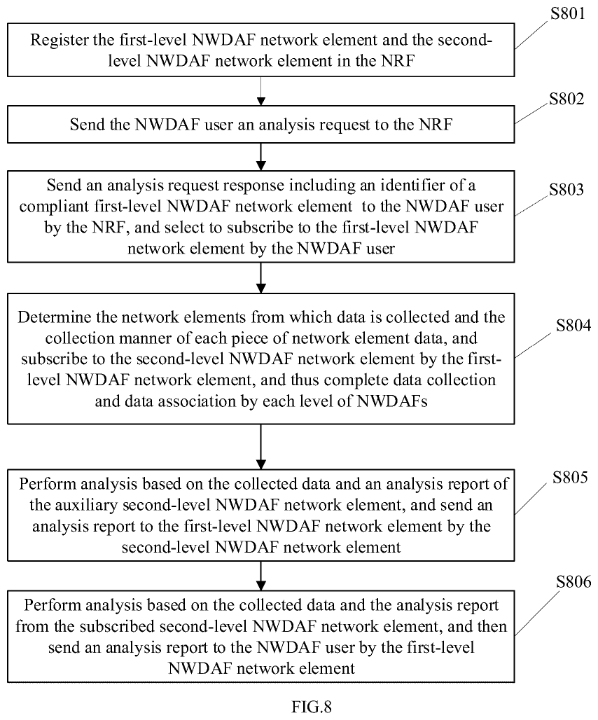

As shown in FIG. 6, an embodiment of the present disclosure provides a data analysis method of a radio network. The method is applied to a second-level NWDAF network element and includes the following step S501.

At step S501, according to a to-be-performed first-class analysis, a second-level analysis report is sent to a first-level NWDAF network element. Where the second-level NWDAF network element is in correspondence with a network slice to which a target user equipment (UE) corresponding to the first-class analysis belongs; the first-level NWDAF network element is configured to, according to the second-level analysis report, send a first-level analysis report to an NWDAF user. The NWDAF user adjusts network parameters of the first-class analysis based on the first-level analysis report.

In the embodiments of the present disclosure, a two-level hierarchical NWDAF architecture is deployed and works such as radio network data collection and association, analysis and subscription and result feedback are carried out on the architecture. In the embodiments of the present disclosure, the first-level NWDAF network element serves shared network elements of a plurality of network slices, the second-level NWDAF network element serves a monopolized network element of a single network slice, and a plurality of second-level NWDAF network elements may serve a monopolized network function of a same network slice.

Herein, the network slice is an on-demand networking manner which allows the operator to separate out a plurality of virtual end-to-end networks on a unified infrastructure. Each of the network slices performs logical isolation from radio access network to a bearer network and then to a core network, so as to adapt to various types of services.

In the embodiments of the present disclosure, an NWDAF user, i.e., an NWDAF service consumer, proposes a requirement for data analysis, namely, the first-class analysis to be performed for the target UE. Thus, the first-level NWDAF network element and the second-level NWDAF network element perform data collection and analysis based on the to-be-performed first-class analysis, and generate a corresponding analysis report. The NWDAF user performs corresponding network parameter adjustment based on the analysis report, so as to achieve network optimization.

The NWDAF network element that the NWDAF user subscribes to is the first-level NWDAF network element. Therefore, the first-level NWDAF network element sends the first-level analysis report to the NWDAF user. The first-level NWDAF network element subscribes to the second-level NWDAF network element, and therefore, the second-level NWDAF network element sends the obtained second-level analysis report to the first-level NWDAF network element, and the first-level NWDAF network element performs further processing on the second-level analysis report to generate the final first-level analysis report.

In the embodiments of the present disclosure, since the second-level NWDAF network element is an NWDAF network in correspondence with the network slice, the second-level NWDAF network element has monopoly over the data of the network slice. The second-level NWDAF network element collects monopolized data in the network slice and performs corresponding analysis and generates a corresponding second-level analysis report. In this process, it is not required to perform data exchange between network slices. The first-level NWDAF network element can perform collection and analysis on shared data between a plurality of network slices.

Thus, compared with the division of the second-level NWDAF network elements based on service area, on one hand, isolation requirement for the network elements between the network slices can be fulfilled to increase data security and on the other hand, the division of the second-level NWDAF network elements based on network slice is more applicable to a scenario where a mobile terminal switches between different service areas, so as to reduce the NWDAF service interruptions resulting from switching of the terminal between service areas, thus improving the use experiences of the users.

Furthermore, compared with the fact that one or more second-level NWDAF network elements are responsible for one service area, the problem of diversity and unbalance may occur to the data analysis requirement in the service area. Thus it is required to deploy a plurality of NWDAFs supporting different analysis types in one service area. In the embodiments of the present disclosure, divided based on network slice, each second-level NWDAF network element is responsible for the monopolized NFs of one network slice. Hence, a smaller number of NWDAFs are deployed in a plurality of service areas, which reduces deployment cost and increases use efficiency.

In some embodiments, the second-level NWDAF network element serves an independent network slice and is configured to analyze at least one network function (NF) monopolized by the network slice.

In one or more embodiments of the present disclosure, the second-level NWDAF network element is used only to serve the independent network slice and can perform collection and analysis and the like on the data of one or more NFs in the served independent network slice. Thus, each independent network slice may correspond to one or more second-level NWDAF network elements.

Processing on the to-be-performed first-class analysis can be performed by using the second-level NWDAF network element supporting the analysis. In this case, isolation on the second-level NWDAF network element is achieved on the network slice, which improves security of data between network slices and service independence, and reduces potential hazard of the data security.

In some embodiments, the second-level NWDAF network element includes at least one of: a first-class network element configured to perform the first-class analysis to obtain the second-level analysis report; and a second-class network element configured to, based on an analysis report sent by an auxiliary NWDAF network element, perform analysis to obtain the second-level analysis report.

The second-level NWDAF network element can perform analysis on the collected data, that is, perform the above first-class analysis on the collected data to obtain the corresponding second-level analysis report. Furthermore, data exchange may be performed between the second-level NWDAF network elements, namely, the auxiliary NWDAF network element is also a second-level NWDAF network element used to assist another second-level network element in data analysis.

The above second-class network element can receive an analysis report sent by the auxiliary NWDAF network element. The analysis report sent by the auxiliary NWDAF network element may be an analysis report obtained by performing the second-class analysis different from the first-class analysis. The analysis report may be used to assist the second-class network element in performing the first-class analysis to obtain the second-level analysis report sent to the first-class network element.

Namely, the data obtained by the auxiliary NWDAF network element by performing the second-class analysis can assist the second-level NWDAF network element in performing the first-class analysis. Thus, the second-level NWDAF network element prepares the analysis report with the assistance of the auxiliary NWDAF network element.

The data of the target UE corresponding to an NF in a same network slice is analyzed by using the first-class network element. And the related data of the target UE between different NFs or different network slices may be analyzed by using the second-class network element such that comprehensive analysis of the data between different NFs or different network slices can be achieved.

In some embodiments, the first-class network element is configured to collect data corresponding to the first-class analysis and based on the data corresponding to the first-class analysis, perform the first-class analysis.

The second-class network element is configured to collect the data corresponding to the first-class analysis and based on the second-level analysis report and the data corresponding to the first-class analysis, perform the first-class analysis.

The auxiliary NWDAF network element is configured to collect data corresponding to a second-class analysis, and based on the data corresponding to the second-class analysis, perform the second-class analysis to obtain the second-level analysis report; where the second-class analysis is an associated analysis of the first-class analysis.

In some embodiments, the second-level NWDAF network element is configured to obtain monopolized NF data and based on the monopolized NF data, send the second-level analysis report to the first-level NWDAF network element.

In the embodiments of the present disclosure, since the second-level NWDAF network element only serves one network slice, the second-level NWDAF network element is used to obtain the monopolized NF data in the network slice and generate the corresponding second-level analysis report. Since the first-level NWDAF network element subscribes to the second-level NWDAF network element, the second-level analysis report, after being sent to the first-level NWDAF network element, is further processed by the first-level NWDAF network element.

In some embodiments, the second-level NWDAF network element is further configured to receive desensitized monopolized NF data from the auxiliary NWDAF network element, where the auxiliary NWDAF network element is configured to perform desensitization on the obtained monopolized NF data and send the desensitized monopolized NF data to the second-level NWDAF network element.

In the embodiments of the present disclosure, it is possible for the second-level NWDAF network element to perform data analysis with the assistance of the auxiliary NWDAF network element. Thus, the second-level NWDAF network element may receive the monopolized NF data sent by the auxiliary NWDAF network element. After collecting the corresponding monopolized NF data, in order to reduce the possibility of lower security resulting from data exchange between network slices, the auxiliary NWDAF network element needs to perform desensitization on the data, for example, remove sensitive information in the monopolized NF data or perform proper encryption on the data or the like.

After the second-level NWDAF network element receives the data provided by the auxiliary NWDAF network element, the second-level NWDAF network element may perform comprehensive processing in combination with the monopolized NF data collected by itself, so as to obtain the corresponding second-level analysis report.

In some embodiments, the method further includes: receiving a second request sent by the first-level NWDAF network element according to the network element identifier of the second-level NWDAF network element, where the second request is used for the second-level NWDAF network element to report analysis data.

The first-level NWDAF network element may subscribe to the second-level NWDAF network element needing to obtain the corresponding data, and thus, the first-level NWDAF network element may, based on the network element identifier of the second-level NWDAF network element determined from the NRF, send the second request to the second-level NWDAF network element. The second-level NWDAF network element sends the corresponding analysis report to the first-level NWDAF network element based on the received second request.

In some embodiments, the second request includes at least one of: identifier information of the first-class analysis; identifier information of the target UE; or identifier information of the second-class analysis associated with the first-class analysis.

The second request has the similar functions to the first request, that is, is used to notify the second-level NWDAF network element of the to-be-performed first-class analysis and/or the second-class analysis associated with the first-class analysis and the target UE to perform analysis and the like. Thus, the second-level NWDAF network element can perform the corresponding analysis based on the second request and provide the analysis report to the first-level NWDAF network element.

In some embodiments, the method further includes: sending a third request to the auxiliary NWDAF network element. Where the third request includes at least one of: identifier information of the target UE; or identifier information of the second-class analysis associated with the first-class analysis.

One second-level NWDAF network element only serves the monopolized NFs of one network slice, and the analysis report desired by the NWDAF user may be generated by performing associated analysis on the data of a plurality of network slices. Therefore, some second-level NWDAF network elements may obtain the associated data analysis reports with the assistance of the auxiliary NWDAF network element. Hence, the second-level NWDAF network element may obtain the corresponding data analysis report by sending the third request to the auxiliary NWDAF network element.

Since the auxiliary NWDAF network element subscribed to by the second-level NWDAF network element does not need to perform the first-class analysis but the second-class analysis associated the first-class analysis, the third request may include information associated with performing analysis by the auxiliary NWDAF network element Specifically including the identifier information of the target UE and the identifier information of the second-class analysis and the like.

An embodiment of the present disclosure provides a data analysis system of a radio network, which includes: a first-level NWDAF network element, configured to perform data analysis on shared data of shared network elements within a plurality of network slices; and at least one second-level NWDAF network element, configured to perform data analysis on monopolized NFs of each network slice within the service scope of the first-level NWDAF network element, where the second-level NWDAF network element is in correspondence with the network slice.

The NWDAF network element is a data perception and analysis network element, which, based on network data, performs automatic perception and analysis on a network and participates in a full life cycle of network planning, construction, operation and maintenance, network optimization and operation. In this way, the network is easily maintained and controlled, and the network resource utilization rate can be increased, and further, the use experience of the users is improved. The NWDAF can collect raw data from a network function (NF), an application function (AF) and operation administration and maintenance (OAM), and perform smart analysis on the raw data, and then feed an analysis result back to the NF, the AF and the OAM and the like for the purpose of network and service optimization. In a NWDAF working cycle, the efficiency of the data collection, and the fusion manner of different dimensions of data and the like have great impact on the analysis and feedback efficiency, intelligent network operation, and the service performance. Therefore, in the embodiments of the present disclosure, efficiency data collection and association method is achieved by using NWDAF.

In the embodiments of the present disclosure, a two-level hierarchical NWDAF architecture is deployed and works such as radio network data collection and association, analysis and subscription and result feedback are carried out on the architecture. In the embodiments of the present disclosure, the first-level NWDAF network element serves shared network elements of a plurality of network slices, the second-level NWDAF network element serves a monopolized network element of a single network slice, and a plurality of second-level NWDAF network elements serve a monopolized network function of a same network slice.

Thus, compared with the division of the second-level NWDAF network elements based on service area, on one hand, isolation requirement for the network elements between the network slices can be fulfilled to increase data security and on the other hand, the division of the second-level NWDAF network elements based on network slice is more applicable to a scenario where a mobile terminal switches between different service areas, so as to reduce the NWDAF service interruptions resulting from switching of the terminal between service areas, thus improving the use experiences of the users.

In some embodiments, the second-level NWDAF network element is further configured to: perform data analysis on the monopolized NFs to obtain a second-level analysis report and send the second-level analysis report to the first-level NWDAF network element. The first-level NWDAF network element is further configured to receive the second-level analysis report and based on the second-level analysis report and the shared data, perform analysis to obtain the first-level analysis report.

In the embodiments of the present disclosure, the second NWDAF network element performs data analysis on the monopolized NFs in the network slice served by the second NWDAF network element to obtain the second-level analysis report. Whereas the first-level NWDAF network element may perform collection and analysis on the shared data of a plurality of network slices and process the second-level analysis report reported by the second-level NWDAF network element. Therefore, the first-level analysis report obtained by the first-level NWDAF network element is obtained by performing comprehensive analysis on the shared data and the second-level analysis report.

In some embodiments, the system further includes: an NWDAF user, configured to adjust the corresponding network parameters based on the first-level analysis report. Herein, the NWDAF user may subscribe to the first-level NWDAF network element to obtain the first-level analysis report from the first-level NWDAF network element, so as to adjust network parameters and optimize network state based on relevant situations of the target UE.

In some embodiments, the system further includes: an NRF, configured to register the first-level NWDAF network element and the second-level NWDAF network element, and based on an analysis request from the NWDAF user, determine the first-level NWDAF network element and the second-level NWDAF network element for performing analysis. Where the NWDAF user is further configured to send an analysis request to the NRF.

In the embodiments of the present disclosure, the first-level NWDAF network element and the second-level NWDAF network element may be registered in the NRF network element. When the NWDAF user obtains an analysis report of the target UE about the first-class analysis, the NWDAF user may send an analysis request to the NRF network element. Based on an analysis request response from the NRF network element, determine the first-level NWDAF network element and the second-level NWDAF network element for performing analysis from the NWDAF network elements registered in the NRF network element. The NWDAF user may send the above first request to the corresponding first-level NWDAF network element based on the analysis request response.

In some embodiments, the system further includes: shared network elements in a plurality of network slices, configured to provide data to the first-level NWDAF network element, where the shared network elements include at least one of: NF; AF; and OAM; where the monopolized NFs of each network slice are configured to provide data to the second-level NWDAF network element.

A plurality of network slices have shared network elements to provide shared data in the plurality of network slices. The first-level NWDAF network element serves a plurality of network slices, and thus can obtain the data from the shared network elements and perform data analysis and processing. Since the second-level NWDAF network element servers a single network slice, the second-level NWDAF network element can collect and analyze the monopolized NF data within the single network slice.

An embodiment of the present disclosure further provides the following example.

As shown FIG. 7 is a schematic diagram illustrating a system architecture corresponding to the data collection and association method of the radio network provided by the embodiments of the present disclosure. The system includes the following network elements: the NRF, the first-level NWDAF network element, the second-level NWDAF network element, the NWDAF user, the NF, the AF and the OAM.

The second-level NWDAF network element serves different network slices and the 5G core network element supports different levels of on-demand isolation modes to ensure the service independence between slices. The isolation modes include the following.
1. Full shared mode: applicable to general consumer services of a public network, where the network slices share all network elements.
2. Partial monopolized mode: applicable to a general industry network, some network elements shared, and some network elements monopolized.
3. Full monopolized mode: applicable to a VIP industry network, with all network elements monopolized, with capability equivalent to one complete industry-specific core network.

In the embodiments of the present disclosure, one or more second-level NWDAF network elements are configured for each network slice to serve the monopolized network elements of the network slice, and the first-level NWDAF network element serves the shared network elements of a plurality of network slices.

Various levels of NWDAFs are registered in the NRF, and the NWDAF user may subscribe to the first-level NWDAF network element by analysis ID. The first-level NWDAF network element may obtain data from the OAM, the AF and the shared NFs of each network slice. The second-level NWDAF network element can only obtain data from the monopolized network elements it serves. Two different second-level NWDAF network elements may serve a same group of monopolized NFs.

As shown in FIG. 8, FIG. 8 is a flowchart corresponding to a data collection and association method of a radio network according to an embodiment of the present disclosure. The method includes the following steps S801 to S806.

At step S801, a first-level NWDAF network element is registered in an NRF, where registration information includes supported analysis ID and information of a plurality of served network slice. A second-level NWDAF network element is registered in the NRF, where registration information includes supported analysis ID, information of the served network slices and the information of the monopolized NFs. Registration using the NF information implicitly indicates it is one second-level NWDAF network element.

At step S802, an NWDAF user sends to the NRF an analysis request including a desired analysis ID denoted as ID1.

At step S803, the NRF sends to the NWDAF user an analysis request response including a compliant first-level NWDAF network element, and the NWDAF user subscribes to the first-level NWDAF network element.

Furthermore, the step S803 includes the following steps S31 to S32, not shown.

At step S31, the NRF sends to the NWDAF user a request response including the identifier of the first-level NWDAF network element supporting the analysis ID1.

At step S32, the NWDAF user subscribes to the first-level NWDAF network element in the request response by the desired analysis ID, where the subscription request includes target UE ID, and associated analysis ID, i.e., the analysis ID corresponding to the analysis type helpful to the desired analysis type and denoted as ID2.

Next, at step S804, the first-level NWDAF network element determines the network elements from which data is collected and the collection manner of each piece of network element data, and subscribes to the second-level NWDAF network element, and thus each level of NWDAFs completes data collection and data association.

Furthermore, the step S804 includes the following steps S41 to S44, not shown.

At step S41, the first-level NWDAF network element subscribes to the second-level NWDAF network element by the analysis ID1, where the subscription information includes the target UE ID and associated analysis ID2.

At step S42, the second-level NWDAF network element subscribes to an auxiliary second-level NWDAF network element by using the analysis ID2 such that the second-level NWDAF network element is assisted in supporting the analysis ID2.

At step S43, the first-level NWDAF network element obtains data from the OAM, the AF, and the shared NF, and the second-level NWDAF network element obtains data from the served monopolized NFs.

At step S44, each level of NWDAFs associates the collected data by using data association identifiers to obtain the end-to-end data of the user.

Then, at step S805, the second-level NWDAF network element performs analysis based on the collected data and an analysis report of the auxiliary second-level NWDAF network element, and sends an analysis report to the first-level NWDAF network element.

Furthermore, the step S805 includes the following steps S51 to S52, not shown.

At step S51, the auxiliary second-level NWDAF network element performs the analysis of the analysis ID2 based on the collected data, and sends an analysis report to the second-level NWDAF network element 1 subscribing to its analysis.

At step S52, the second-level NWDAF network element performs the analysis of the analysis ID1 based on the collected data with the analysis report of the auxiliary second-level NWDAF network element as assistance, and then sends an analysis report to the first-level NWDAF network element after completing the analysis.

Then, at step S806, the first-level NWDAF network element performs analysis based on the collected data with the analysis report from the second-level NWDAF network element as assistance, and then sends an analysis report to the NWDAF user.

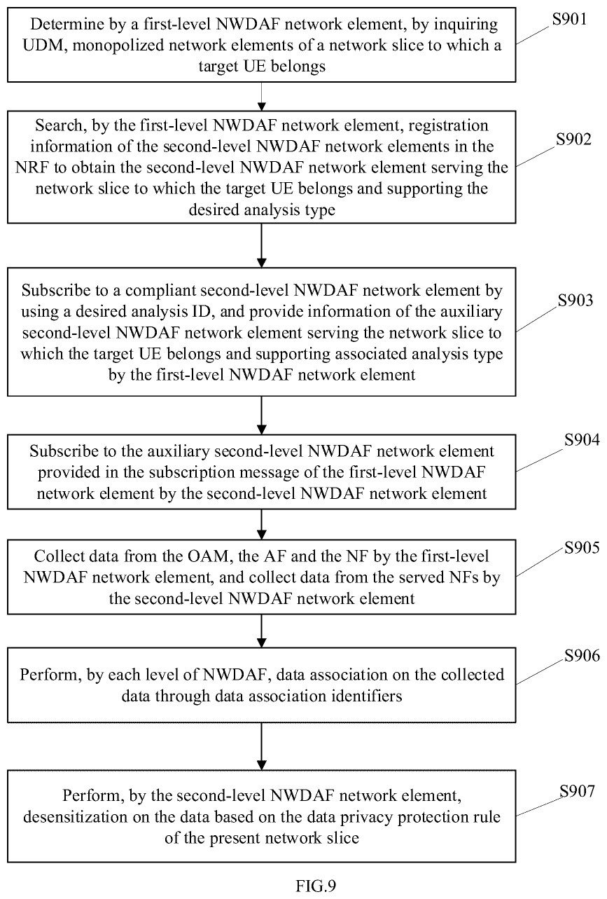

As shown FIG. 9 is a flowchart illustrating network data collection and association in a data collection and association method of a radio network according to an embodiment of the present disclosure. The method includes the following steps S901 to S907.

At step S901, a first-level NWDAF network element determines, by inquiring UDM, monopolized NFs of a network slice to which a target UE belongs.

In one embodiment, the network slices share AMF, UDM, PCF and the like, and each network slice has monopolized UPF and SMF network elements. Thus, each second-level NWDAF network element serves the monopolized NFs of one network slice. For example, the target UE belongs to a network slice 1, and thus, the monopolized NFs serving it are UPF1 and SMF1.

At step S902, the first-level NWDAF network element searches registration information of the second-level NWDAF network elements in the NRF to obtain the second-level NWDAF network element serving the network slice to which the target UE belongs and supporting the desired analysis type, and obtain the analysis ID supported by the second-level NWDAF network element and the information of the served monopolized NFs.

In one embodiment, the second-level NWDAF network element 1 supports the analysis ID1 and serves the monopolized NFs of the network slice to which the target UE belongs; the second-level NWDAF network element 2 supports the analysis ID2 and serves the monopolized NFs of the network slice to which the target UE belongs; and the second-level NWDAF network element N supports the analysis ID1 and does not serve the monopolized NFs of the network slice to which the target UE belongs.

At step S903, the first-level NWDAF network element subscribes to a compliant second-level NWDAF network element by using a desired analysis ID, and provides information of the auxiliary second-level NWDAF network element serving the network slice to which the target UE belongs and supporting associated analysis type.

Furthermore, the step S903 includes the following steps S61 to S62, not shown.

At step S61, the first-level NWDAF network element subscribes to the second-level NWDAF network element 1 by the analysis ID1, where the subscription information includes target UE ID and association analysis Id (analysis ID2); and the first-level NWDAF network element provides an identifier of the second-level NWDAF network element 2 serving the network slice to which the target UE belongs and supporting the analysis ID2.

At step S62, the first-level NWDAF network element subscribes to the second-level NWDAF network element N by the analysis ID1, where the subscription information includes target UE ID and associated analysis ID (analysis ID2).

Then, at step S904, the second-level NWDAF network element 1 subscribes to the second-level NWDAF network element 2 by the analysis ID2, where the subscription information includes target UE ID.

At step S905, the first-level NWDAF network element collects data from the OAM, the AF and the NF, and the second-level NWDAF network element collects data from the served NFs.

Furthermore, the step S905 includes the following steps S71 to S74, not shown.

At step S71, the first-level NWDAF network element collects data from the shared NFs/internal AF.

At step S72, the first-level NWDAF network element collects data from the OAM.

At step S73, the first-level NWDAF network element collects data from a third party AF through NEF.

At step S74, the second-level NWDAF network element collects data from the served monopolized NFs.

The steps S71 to S74 may be performed without sequence, for example, at the same time.

Then, at step S906, each level of NWDAF performs data association on the collected data through data association identifiers.

At step S907, each second-level NWDAF network element performs desensitization on the data based on the data privacy protection rule of the present network slice. And, when the other NWDAFs request collection of data of the monopolized network elements in the slice, sends the processed data.

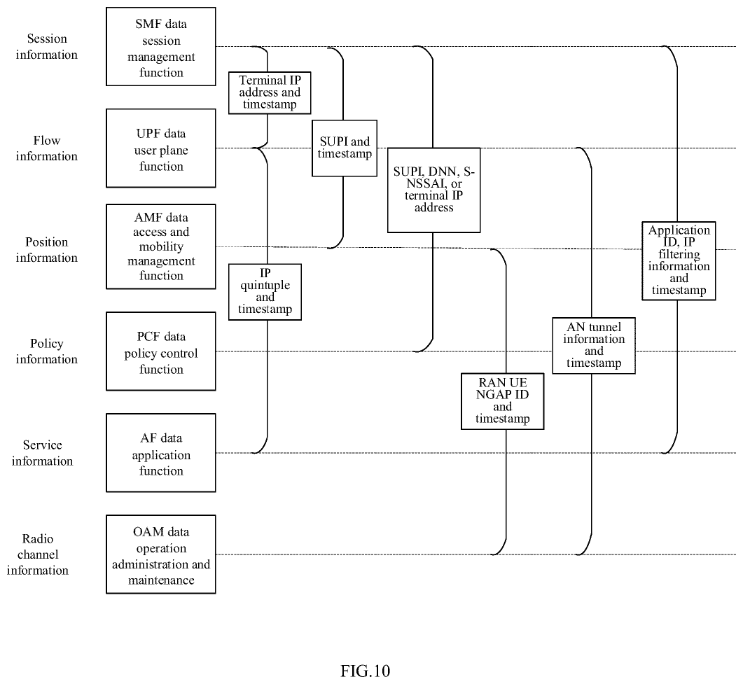

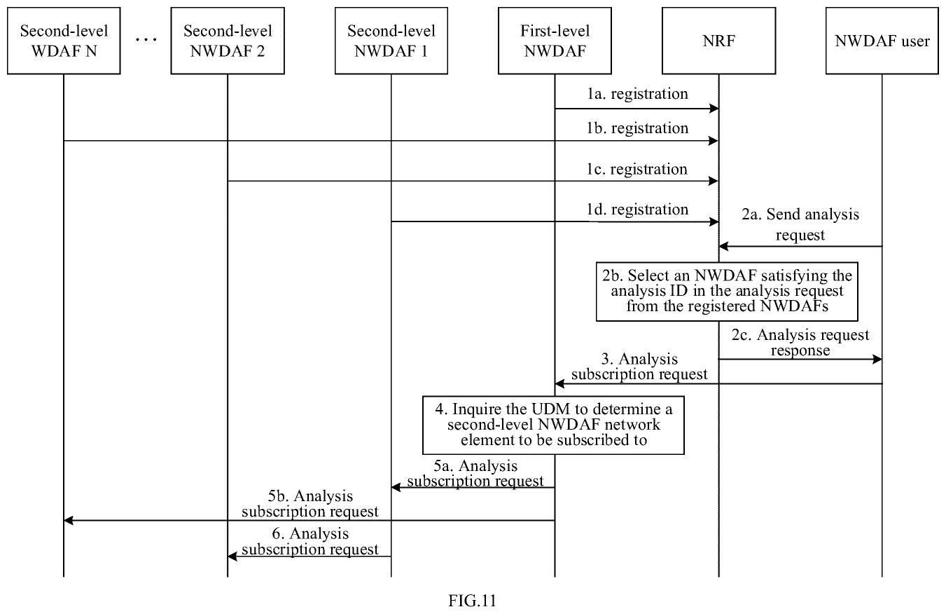

As shown in FIG. 10, FIG. 10 is a schematic diagram illustrating data association identifiers in a data collection and association method of a radio network according to an embodiment of the present disclosure. The NWDAF may collect data from each network element, and the data of a same user is usually distributed on different network elements. In order to obtain the end-to-end data of the user, it is required to associate the data collected from the network elements by the data association identifiers. The association method of the data collected from the core network elements SMF, UPF, AMF, PCF, AF and OAM will be described below in combination with accompanying drawings.

The main information the NWDAF collects from each network element is as follows.
1. The SMF refers to a Session Management Function network element and the SMF data mainly includes session information.
2. The UPF refers to a User Plane Function network element, and the UPF data mainly includes flow information.
3. The AMF refers to an Access and Mobility Management Function network element and the AMF data mainly includes user position information.
4. The PCF refers to a Policy Control Function network element, and the PCF data mainly includes policy information.
5. The AF refers to an Application Function network element and the AF data mainly includes service information.
6. The OAM refers to an Operation Administration and Maintenance network element and the OAM data from the RAN side mainly includes radio channel information.

The method of associating the data collected from the network elements by the data association identifiers is as follows.
1. The SMF data and the UPF data may be associated by using the IP address of the terminal and the timestamp.
2. The UPF data and the AF data may be associated by using the IP quintuple and the timestamp.
3. The SMF data and the AMF data may be associated by using the SUPI and the timestamp.
4. The SMF data and the PCF data may be associated by using the SUPI, the DNN, the S-NSSAI or the IP address of the terminal.
5. The AMF data and the OAM data may be associated by using the RAN UE NGAP ID and the timestamp.
6. The UPF data and the OAM data may be associated by using the AN tunnel information and the timestamp.
7. The SMF data and the AF data may be associated by using the application ID, the IP filtering information and the timestamp.

The IP quintuple includes a source IP address, a source port, a destination IP address, a destination port and a transport layer protocol. The SUPI is a unique permanent identifier of a user in the 5G network. The DNN is a data network name. The S-NSSAI is a unique identifier of a network slice. The RAN UE NGAP ID is an application protocol identifier of user equipment NG interface of a radio access network, where the RAN UE NGAP ID is unique in the NG-RAN node. The AN tunnel information includes endpoint IP address and GTP tunnel endpoint identifier.

As shown in FIG. 11, FIG. 11 is a principle diagram of a protocol and an interface for registration, analysis and subscription in a data collection and association method of a radio network according to an exemplary embodiment of the present disclosure, which mainly involves the NWDAF user, the NRF, the first-level NWDAF network element, the second-level NWDAF network element 1, the second-level NWDAF network element 2 and the second-level NWDAF network element N in the system.
1a. The first-level NWDAF network element is registered to the NRF, where the registration information includes an analysis ID supported by the first-level NWDAF network element.

In one embodiment, the first-level NWDAF network element supports an analysis ID1 and an analysis ID2.
1b. The second-level NWDAF network element N is registered to the NRF, where the registration information includes the analysis ID supported by the second-level NWDAF network element N, the network slice served by it, and the corresponding monopolized NF IDs.

In one embodiment, the second-level NWDAF network element N supports the analysis ID1, serves the network slice 1, and corresponds to the monopolized NF m1, . . . and the monopolized NF mj.
1c. The second-level NWDAF network element 2 is registered to the NRF, where the registration information includes the analysis ID supported by the second-level NWDAF network element 2, the network slice served by it and the corresponding monopolized NF IDs.

In one embodiment, the second-level NWDAF network element 2 supports the analysis ID2, serves the network slice 2, and corresponds to the monopolized NF I1, . . . and the monopolized NF Ij.
1d. The second-level NWDAF network element 1 is registered to the NRF, where the registration information includes the analysis ID supported by the second-level NWDAF network element 1, the network slice served by it and the corresponding monopolized NF IDs.

In one embodiment, the second-level NWDAF network element 1 supports the analysis ID1, serves the network slice 2, and corresponds to the monopolized NF I1, . . . and the monopolized NF Ij.
2a. The NWDAF user sends an analysis request message to the NRF, where the analysis request message includes a desired analysis ID.

In one embodiment, the analysis ID desired by the NWDAF user is the analysis ID1.
2b. The NRF selects, from the registered NWDAFs, the first-level NWDAF network element supporting the analysis ID in the analysis request message.
2c. The NRF sends an analysis request response to the NWDAF user, where the analysis request response includes the identifier of the compliant first-level NWDAF network element.
3. The NWDAF user subscribes to the first-level NWDAF network element through the service request Nnwdaf AnalyticsSubscription Subscribe, where the analysis subscription request message includes the analysis ID1, the target UE ID, and the associated analysis ID.

In one embodiment, the associated analysis ID of the analysis ID1 is the analysis ID2.
4. The first-level NWDAF network element determines the network slice to which the target UE belongs by inquiring UDM to obtain the monopolized network elements serving the target UE, and then based on the analysis ID supported by the second-level NWDAF network element in the registration information of the second-level NWDAF network element and the served monopolized NFs, determines the second-level NWDAF network element to be subscribed to.

In one embodiment, the second-level NWDAF network element 1 supports the analysis ID1 and serves the monopolized NFs of the network slice to which the target UE belongs. The second-level NWDAF network element 2 supports the analysis ID2 and serves the monopolized NFs of the network slice to which the target UE belongs. And the second-level NWDAF network element N supports the analysis ID1 and does not serve the monopolized NFs of the network slice to which the target UE belongs. Thus, the first-level NWDAF network element needs to subscribe to the second-level NWDAF network element 1 and the second-level NWDAF network element N supporting the analysis ID1.
5a. The first-level NWDAF network element subscribes to the second-level NWDAF network element 1 through the service request Nnwdaf AnalyticsSubscription Subscribe, where the analysis subscription request message includes the analysis ID1, the target UE ID, the associated analysis ID 2, and the identifier of the second-level NWDAF network element, i.e., the second-level NWDAF network element 2 supporting the associated analysis ID and serving the monopolized NFs of the network slice to which the target UE belongs.
5b. The first-level NWDAF network element subscribes to the second-level NWDAF network element N through the service request Nnwdaf AnalyticsSubscription Subscribe, where the analysis subscription request message includes the analysis ID1, the target UE ID and the associated analysis ID2.
6. The second-level NWDAF network element 1 subscribes to the NWDAF 2 through the service request Nnwdaf AnalyticsSubscription Subscribe, where the analysis subscription request message includes the analysis ID 2 and the target UE ID.

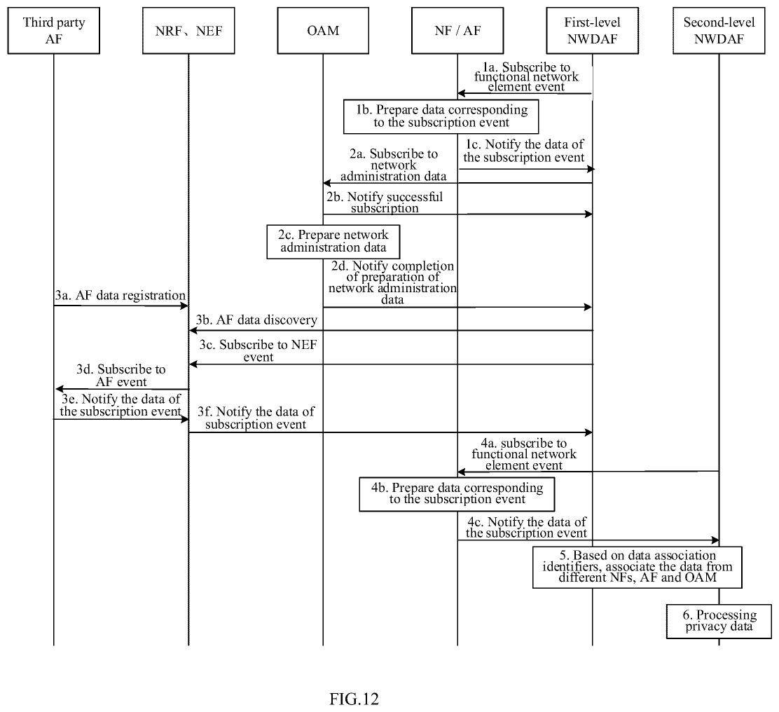

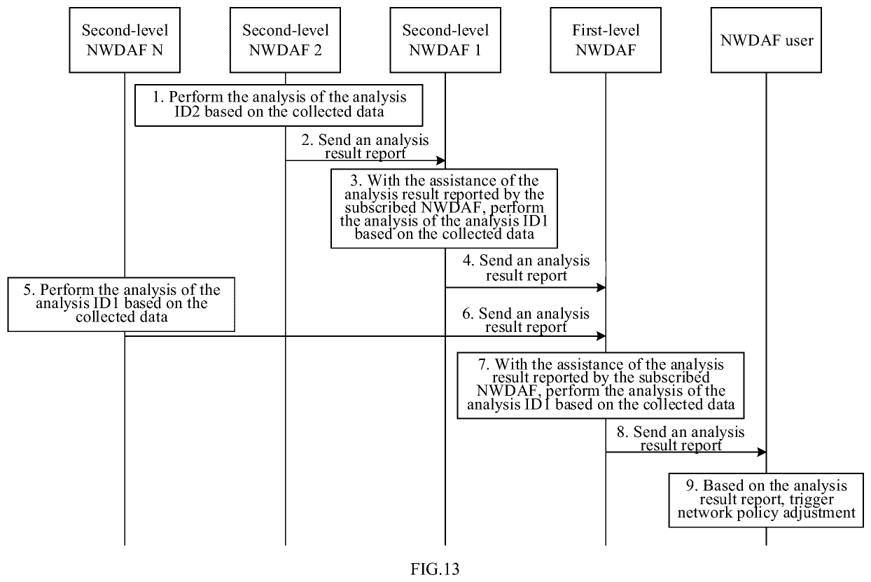

As shown in FIG. 12, FIG. 12 is a principle diagram of a protocol and an interface for network data collection and association in a data collection and association method of a radio network according to an exemplary embodiment of the present disclosure, which mainly involves third party AF, NRF, NEF, OAM, NF, AF, first-level NWDAF network element and second-level NWDAF network element. In the drawing, the NRF and the NEF, and the NF and the internal AF are integrated respectively into one part for the purpose of clarity of the drawing and will be further elaborated during specific descriptions.
1a. The first-level NWDAF network element subscribes to the event of the functional network element from the shared NF/internal AF through the service Nnf EventExposure Subscribe/Naf EventExposure Subscribe.
1b. The NF/internal AF prepare the data corresponding to the subscription event.
1c. If the NF/internal AF prepare the data, data of the subscription event is provided to the first-level NWDAF network element through the service Nnf/Naf EventExposure Notify.
2a. The first-level NWDAF network element sends a message for subscribing to network administration data to the OAM.
2b. The OAM sends a message indicating successful subscription to the first-level NWDAF network element.
2c. The OAM prepares network administration data.
2d. The OAM sends a message indicating completion of preparation of the network administration data to the first-level NWDAF network element and notifies the first-level NWDAF network element of a data storage address. The first-level NWDAF network element obtains the OAM data from the storage address through FTP.
3a. The third party AF registers data information to the NRF through NEF.
3b. The first-level NWDAF network element sends an AF data discovery message to the NRF and searches the data registration information in the NRF for the third party AF possibly capable of providing the desired data.
3c. The first-level NWDAF network element subscribes to the NEF event from the NEF through the service Nnef EventExposure Subscribe.
3d. The NEF subscribes to the AF event from the AF through the service Naf EventExposure Subscribe.
3e. The AF provides data of the subscription event to the NEF through the service Naf EventExposure Notify.
3f. The NEF provides data of the subscription event to the first-level NWDAF network element through the service Nnef EventExposure Notify.
4a. The second-level NWDAF network element subscribes to the event of the functional network elements from the monopolized NFs through the service Nnf EventExposure Subscribe.
4b. The monopolized NFs prepare data corresponding to the subscription event.
4c. If the monopolized NF already prepares the data, data of the subscription event is provided to the second-level NWDAF network element through the service Nnf EventExposure Notify.
5. Each level of NWDAF associates the data from different NFs, AF, and OAM by using the data association identifiers to realize end-to-end association of user data.
6. When other NWDAFs request the data of the monopolized network elements of the present network slice, the corresponding second-level NWDAF network element collects the data and performs desensitization on the data based on the data privacy protection rule of the present network slice.

The steps 1a to 1c are a process in which the first-level NWDAF network element collects data from the shared NFs/internal AF, the steps 2a to 2d are a process in which the first-level NWDAF network element collects data from the OAM, the steps 3a to 3f are a process in which the first-level NWDAF network element collects data from the third party AF, and the steps 4a to 4c are a process in which the second-level NWDAF network element collects data from the served monopolized NFs. The above four processes can be performed without sequence, for example, at the same time.

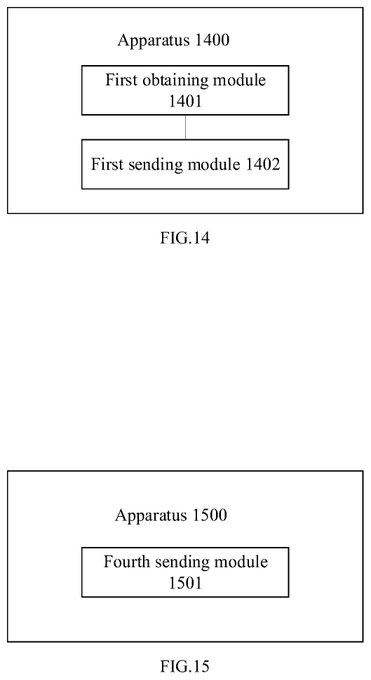

As shown in FIG. 13, FIG. 13 is a principle diagram of a protocol and an interface for an NWDAF to perform analysis and result feedback in a data collection and association method of a radio network according to an exemplary embodiment of the present disclosure. As required, the cooperation between the NWDAFs provides subscription to the data collected by the NWDAFs or the analysis results. The following descriptions are made with an analysis report as an example.
1. The second-level NWDAF network element 2 performs the analysis of the analysis ID2 based on the collected data.
2. The second-level NWDAF network element 2 sends an analysis result report to the second-level NWDAF network element 1 through the service Nnwdaf AnalyticsSubscription Notify.
3. The second-level NWDAF network element 1 performs the analysis of the analysis ID1 based on the collected data with the assistance of the analysis report provided by the second-level NWDAF network element 2.
4. The second-level NWDAF network element 1 sends an analysis result report to the first-level NWDAF network element through the service Nnwdaf AnalyticsSubscription Notify.
5. The second-level NWDAF network element N performs the analysis of the analysis ID1 based on the collected data.
6. The second-level NWDAF network element N sends an analysis result report to the first-level NWDAF network element through the service Nnwdaf AnalyticsSubscription Notify.
7. The first-level NWDAF network element sends performs the analysis of the analysis ID1 based on the collected data with the assistance of the analysis report sent by the second-level NWDAF network element N.
8. The first-level NWDAF network element sends an analysis result report to the NWDAF user through the service Nnwdaf AnalyticsSubscription Notify.
9. The NWDAF user triggers adjustment to the network and service optimization policy based on the analysis result report.

As shown in FIG. 14, an embodiment of the present disclosure provides a data analysis apparatus 1400 of a radio network, which is applied to a first-level NWDAF network element. The apparatus 1400 includes a first obtaining module 1401 and a first sending module 1402.

The first obtaining module 1401 is configured to, according to a to-be-performed first-class analysis, obtain a second-level analysis report sent by a second-level NWDAF network element in correspondence with a network slice to which a target user equipment (UE) belongs.

The first sending module 1402 is configured to, according to the second-level analysis report, send a first-level analysis report to an NWDAF user, where the NWDAF user adjusts network parameters of the first-class analysis according to the first-level analysis report.

In some embodiments, the second-level NWDAF network element serves an independent network slice and is configured to analyze at least one network function (NF) monopolized by the network slice.

In some embodiments, the second-level NWDAF network element includes at least one of: a first-class network element configured to perform the first-class analysis to obtain the second-level analysis report; or a second-class network element configured to, based on an analysis report sent by an auxiliary NWDAF network element, perform analysis to obtain the second-level analysis report.

In some embodiments, the first-class network element is configured to collect data corresponding to the first-class analysis and based on the data corresponding to the first-class analysis, perform the first-class analysis. The second-class network element is configured to collect the data corresponding to the first-class analysis and data provided by the auxiliary NWDAF network element and perform the first-class analysis. The auxiliary NWDAF network element is configured to collect data corresponding to a second-class analysis, and based on the data corresponding to the second-class analysis, perform the second-class analysis to obtain the second-level analysis report. Wherein the second-class analysis is an associated analysis of the first-class analysis.

In some embodiments, the apparatus 1400 further includes at least one of: a second obtaining module (not shown), configured to, based on the first-class analysis, obtain to-be-analyzed shared data from a shared network element; and a second sending module (not shown), configured to, according to the second-level analysis report, send the first-level analysis report to the NWDAF user, where sending the first-level analysis report to the NWDAF user includes according to the shared data and the second-level analysis report, sending the first-level analysis report to the NWDAF user.

In some embodiments, the shared network element includes at least one of: a shared network function (NF); an internal application function (AF); a third party AF; operation administration and maintenance (OAM); or a network exposure function (NEF).

In some embodiments, the second-level NWDAF network element is configured to obtain monopolized NF data, and based on the monopolized NF data, send the second-level analysis report to the first-level NWDAF network element.

In some embodiments, the monopolized NF data and the shared data obtained by the first-level NWDAF network element from the shared network element both carry data association identifiers which are used to identify an association relationship between each piece of data and the target UE.

In some embodiments, the data association identifiers include at least one of: an internet protocol (IP) address of the target UE; an IP quintuple; a timestamp; a subscription permanent identifier (SUPI); a data network name (DNN); a single network slice selection assistance information (S-NSSAI); an application protocol identifier of user equipment NG interface of a radio access network; or access network (AN) tunnel information.

In some embodiments, the second-level NWDAF network element is further configured to receive monopolized NF data from the auxiliary NWDAF network element, and the auxiliary NWDAF network element is configured to perform desensitization on the obtained monopolized NF data and send the desensitized monopolized NF data to the second-level NWDAF network element.

In some embodiments, the apparatus 1400 further includes at least one of: a first receiving module (not shown), configured to receive a first request from the NWDAF user; and a first determining module (not shown), configured to, based on the first request, determine a second-level NWDAF network element for obtaining the second-level analysis report.

In some embodiments, the first determining module includes: an obtaining sub-module, configured to, based on the first request, obtain a network element identifier of the second-level NWDAF network element from UDM.

In some embodiments, the first request includes at least one of: identifier information of the first-class analysis; identifier information of the target UE; or identifier information of the second-class analysis associated with the first-class analysis.

In some embodiments, the obtaining sub-module includes: a first determining sub-module, configured to, based on the first request, determine from the UDM information of the monopolized NFs of a network slice to which the target UE belongs; and a second determining sub-module, configured to, based on the information of the monopolized NFs, determine a network element identifier of the second-level NWDAF network element serving the network slice to which the target UE belongs from the second-level NWDAF network elements registered in a network repository function (NRF) network element.

In some embodiments, the apparatus 1400 further includes: a third sending module (not shown), configured to, according to the network element identifier of the second-level NWDAF network element, send a second request to the second-level NWDAF network element, where the second request is used by the second-level NWDAF network element to report analysis data.

In some embodiments, the second request includes at least one of: identifier information of the first-class analysis; identifier information of the target UE; or identifier information of the second-class analysis associated with the first-class analysis.

In some embodiments, the second-level NWDAF network element is further configured to send a third request to the auxiliary NWDAF network element. Where the third request includes at least one of: identifier information of the target UE; or identifier information of the second-class analysis associated with the first-class analysis.

In some embodiments, the first request is a request sent by the NWDAF user to the first-level NWDAF network element registered in the NRF network element.

In some embodiments, the NRF is used to receive an analysis request from the NWDAF user, and based on the analysis request, send an analysis request response to the NWDAF user. Where the analysis request includes the identifier information of the first-class analysis, and the analysis request response is used by the NWDAF user to determine to send the first request to the first-level NWDAF network element.

In some embodiments, the NWDAF network elements registered in the NRF at least include the first-level NWDAF network element and the second-level NWDAF network element.

As shown in FIG. 15, an embodiment of the present disclosure further provides a data analysis apparatus 1500 of a radio network, which is applied to a second-level NWDAF network element. The apparatus 1500 includes a fourth sending module 1501.

The fourth sending module 1501 is configured to, according to a to-be-performed first-class analysis, send a second-level analysis report to a first-level NWDAF network element. Where the second-level NWDAF network element is in correspondence with a network slice to which a target user equipment (UE) corresponding to the first-class analysis belongs. The first-level NWDAF network element is configured to, according to the second-level analysis report, send a first-level analysis report to an NWDAF user. The NWDAF user adjusts network parameters of the first-class analysis based on the first-level analysis report.

In some embodiments, the second-level NWDAF network element serves an independent network slice and is configured to analyze at least one network function (NF) monopolized by the network slice.

In some embodiments, the second-level NWDAF network element includes at least one of: a first-class network element configured to perform the first-class analysis to obtain the second-level analysis report; or a second-class network element configured to, based on an analysis report sent by an auxiliary NWDAF network element, perform analysis to obtain the second-level analysis report.

In some embodiments, the first-class network element is configured to collect data corresponding to the first-class analysis and based on the data corresponding to the first-class analysis, perform the first-class analysis. The second-class network element is configured to collect the data corresponding to the first-class analysis and data provided by the auxiliary NWDAF network element, and perform the first-class analysis. The auxiliary NWDAF network element is configured to collect data corresponding to a second-class analysis, and based on the data corresponding to the second-class analysis, perform the second-class analysis to obtain the second-level analysis report; where the second-class analysis is an associated analysis of the first-class analysis.

In some embodiments, the second-level NWDAF network element is configured to obtain monopolized NF data, and based on the monopolized NF data, send the second-level analysis report to the first-level NWDAF network element.

In some embodiments, the second-level NWDAF network element is further configured to receive desensitized monopolized NF data from the auxiliary NWDAF network element. The auxiliary NWDAF network element is configured to perform desensitization on the obtained monopolized NF data and send the desensitized monopolized NF data to the second-level NWDAF network element.

In some embodiments, the apparatus 1500 further includes: a second receiving module (not shown), configured to receive a second request sent by the first-level NWDAF network element based on a network identifier of the second-level NWDAF network element, where the second request is used by the second-level NWDAD network element to report analysis data.

In some embodiments, the second request includes at least one of: identifier information of the first-class analysis; identifier information of the target UE; or identifier information of the second-class analysis associated with the first-class analysis.

In some embodiments, the apparatus 1500 further includes: a fifth sending module (not shown), configured to send a third request to the auxiliary NWDAF network element. Where the third request includes at least one of: identifier information of the target UE; or identifier information of the second-class analysis associated with the first-class analysis.

The specific manners in which the modules in the apparatus of the above embodiments perform operations have already been detailed in the method embodiments and thus will not be repeated herein.

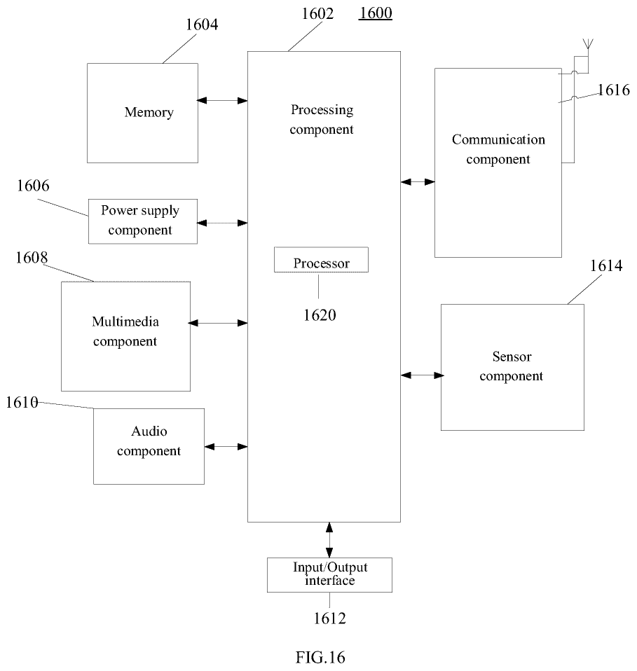

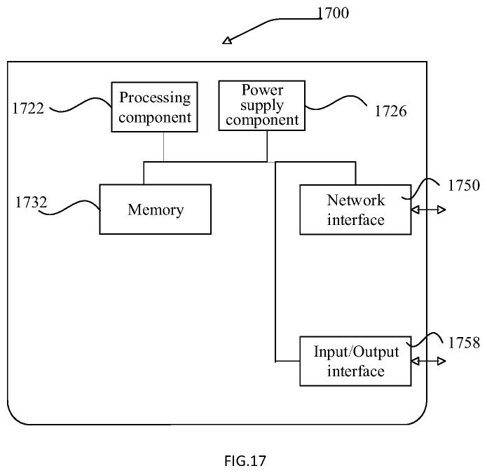

FIG. 16 is a block diagram of a communication device 1600 according to an embodiment of the present disclosure. For example, the communication device 1600 may be a terminal or a user equipment involved in any one of the above embodiments. For example, the communication device 1600 may be a mobile phone, a computer, a digital broadcast user equipment, a message transceiver, a game console, a tablet device, a medical device, a fitness device, a personal digital assistant, and the like.

As shown in FIG. 16, the communication device 1600 may include one or more of the following components: a processing component 1602, a memory 1604, a power supply component 1606, a multimedia component 1608, an audio component 1610, an input/output (I/O) interface 1612, a sensor component 1614 and a communication component 1616.

The processing component 1602 generally controls overall operations of the communication device 1600, such as operations associated with display, phone calls, data communications, camera operations, and recording operations. The processing component 1602 may include one or more processors 1620 to execute instructions to complete all or part of the steps of the above methods. In addition, the processing component 1602 may include one or more modules which facilitate the interaction between the processing component 1602 and other components. For example, the processing component 1602 may include a multimedia module to facilitate the interaction between the multimedia component 1608 and the processing component 1602. One of ordinary skill in the art would readily know and understand the types of modules and their configurations.

The memory 1604 is configured to store various types of data to support the operation of the communication device 1600. Examples of such data include instructions for any application or method operated on the communication device 1600, contact data, phonebook data, messages, pictures, videos, and so on. The memory 1604 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or compact disk.

The power supply component 1606 supplies power for different components of the communication device 1600. The power supply component 1606 may include a power supply management system, one or more power supplies, and other components associated with generating, managing and distributing power for the communication device 1600.

The multimedia component 1608 includes a screen that provides an output interface between the communication device 1600 and a user. In some examples, the screen may include a liquid crystal display (LCD) and a touch panel (TP). If the screen includes a touch panel, the screen may be implemented as a touch screen to receive input signals from the user. The touch panel includes one or more touch sensors to sense touches, slides, and gestures on the touch panel. The touch sensor may not only sense the boundary of touch or slide actions but also detect the duration and pressure associated with touch or slide operations. In some examples, the multimedia component 1608 includes a front camera and/or a rear camera. When the communication device 1600 is in an operation mode, such as a shooting mode or a video mode, the front camera and/or the rear camera may receive external multimedia data. Each of the front and rear cameras may be a fixed optical lens system or have a focal length and an optical zoom capability.

The audio component 1610 is configured to output and/or input audio signals. For example, the audio component 1610 includes a microphone (MIC) configured to receive an external audio signal when the communication device 1600 is in an operation mode, such as a call mode, a recording mode, and a voice recognition mode. The received audio signal may be further stored in the memory 1604 or transmitted via the communication component 1616. In some examples, the audio component 1610 also includes a loudspeaker for outputting an audio signal.

The I/O interface 1612 provides an interface between the processing component 1602 and a peripheral interface module which may be a keyboard, a click wheel, a button, or the like. These buttons may include, but are not limited to a home button, a volume button, a start button, and a lock button.

The sensor component 1614 includes one or more sensors for providing a status assessment in various aspects to the communication device 1600. For example, the sensor component 1614 may detect an open/closed state of the communication device 1600, and the relative positioning of components, for example, the component is a display and a keypad of the communication device 1600. The sensor component 1614 may also detect a change in position of the communication device 1600 or a component of the communication device 1600, the presence or absence of a user in contact with the communication device 1600, the orientation or acceleration/deceleration of the communication device 1600 and a change in temperature of the communication device 1600. The sensor component 1614 may include a proximity sensor configured to detect the presence of nearby objects without any physical contact. The sensor component 1614 may also include a light sensor, such as a CMOS or CCD image sensor, for use in imaging applications. In some examples, the sensor component 1614 may also include an acceleration sensor, a gyro sensor, a magnetic sensor, a pressure sensor, or a temperature sensor.

The communication component 1616 is configured to facilitate wired or wireless communication between the communication device 1600 and other devices. The communication device 1600 may access a wireless network based on a communication standard, such as WiFi, 2G or 3G, or a combination thereof. In an example, the communication component 1616 receives broadcast signals or broadcast associated information from an external broadcast management system via a broadcast channel. In an example, the communication component 1616 also includes a near field communication (NFC) module to facilitate short range communication. For example, the NFC module may be implemented based on a radio frequency identification (RFID) technology, an infrared data association (IrDA) technology, an ultrawideband (UWB) technology, a Bluetooth (BT) technology, and other technologies.

In an example, the communication device 1600 may be implemented by one or more of an application specific integrated circuit (ASIC), a digital signal processor (DSP), a digital signal processing device (DSPD), a programmable logic device (PLD), a field programmable gate array (FPGA), a controller, a microcontroller, a microprocessor or other electronic elements for performing the above methods.

In an example, there is provided a non-transitory computer-readable storage medium storing instructions, for example, a storage medium 1604 storing instructions. The instructions may be executed by the processor 1620 of the communication device 1600 to complete the above methods. For example, the non-transitory computer readable storage medium may be a Read-Only Memory (ROM), a Random Access Memory (RAM), CD-ROM, a magnetic tape, a floppy disk, and an optical data storage device and so on.

As shown in FIG. 17, an embodiment of the present disclosure shows a structure of another communication device. For example, the communication device 1700 may be provided as a network device. As shown in FIG. 17, the communication device 1700 may include a processing component 1722 which further includes one or more processors (not shown) and memory resources represented by a memory 1732 for storing instructions executable by the processing component 1722, for example, an application program. The application program stored in the memory 1732 may include one or more modules, each of which corresponds to one set of instructions. Further, the processing component 1722 is configured to execute instructions to perform the above methods applied to the communication device.

The communication device 1700 further includes one power supply component 1726 configured to execute power management for the communication device 1700, one wired or wireless network interface 1750 configured to connect the communication device 1700 to a network, and one input/output (I/O) interface 1758. The communication device 1700 may be operated based on an operating system stored in the memory 1732, such as Windows Server™, Mac OS X™, Unix™, Linux™ and FreeBSD™.

Other implementations of the present disclosure will be apparent to those skilled in the art from consideration of the specification and practice of the present disclosure herein. The present disclosure is intended to cover any variations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure being indicated by the following claims.

It is to be understood that the present disclosure is not limited to the precise structure described above and shown in the accompanying drawings, and that various modifications and changes may be made without departing from the scope thereof. The scope of the present disclosure is limited only by the appended claims.

1. A data analysis method of a radio network, applied to a first-level network data analytics function (NWDAF) network element and comprising:
according to a to-be-performed first-class analysis, obtaining a second-level analysis report sent by a second-level NWDAF network element in correspondence with a network slice to which a target user equipment (UE) belongs; and
according to the second-level analysis report, sending a first-level analysis report to an NWDAF user, wherein the NWDAF user is configured to adjust network parameters of the a first-class analysis according to the first-level analysis report.

2. The method of claim 1, wherein the second-level NWDAF network element serves an independent network slice and is configured to analyze at least one network function (NF) monopolized by the independent network slice.

3. The method of claim 1, wherein the second-level NWDAF network element comprises at least one of:
a first-class network element configured to perform the first-class analysis to obtain the second-level analysis report; or
a second-class network element configured to, based on an analysis report sent by an auxiliary NWDAF network element, perform a second-class analysis to obtain the second-level analysis report.

4. The method of claim 3, wherein
the first-class network element is configured to collect data corresponding to the first-class analysis and based on the data corresponding to the first-class analysis, perform the first-class analysis;
the second-class network element is configured to collect the data corresponding to the first-class analysis and data provided by the auxiliary NWDAF network element, and perform the first-class analysis; and
the auxiliary NWDAF network element is configured to collect data corresponding to a second-class analysis, and based on the data corresponding to the second-class analysis, perform the second-class analysis to obtain the second-level analysis report, wherein the second-class analysis is an associated analysis of the first-class analysis.

5. The method of claim 1, further comprising:
based on the first-class analysis, obtaining to-be-analyzed shared data from a shared network element;
wherein according to the second-level analysis report, sending the first-level analysis report to the NWDAF user comprises:
according to the to-be-analyzed shared data and the second-level analysis report, sending the first-level analysis report to the NWDAF user, and
wherein the shared network element comprises at least one of:
a shared network function (NF); an internal application function (AF); a third party AF; operation administration and maintenance (OAM); or a network exposure function (NEF).

6. (canceled)

7. The method of claim 1, wherein
the second-level NWDAF network element is configured to obtain monopolized network function data, and based on the monopolized network function data, send the second-level analysis report to the first-level NWDAF network element, and
the monopolized network function data and shared data obtained by a first-level NWDAF network element from the shared network element both carry data association identifiers which are configured to identify an association relationship between the target UE and each piece of the monopolized network function data and the shared data.

8. (canceled)

9. The method of claim 87, wherein the data association identifiers comprise at least one of:
an internet protocol (IP) address of the target UE;
an IP quintuple;
a timestamp;
a subscription permanent identifier (SUPI);
a data network name (DNN);
single network slice selection assistance information (S-NSSAI);
an application protocol identifier of user equipment NG interface of a radio access network; or
access network (AN) tunnel information.

10. The method of claim 1, wherein
the second-level NWDAF network element is further configured to receive desensitized monopolized network function data from an auxiliary NWDAF network element, and
the auxiliary NWDAF network element is configured to perform desensitization on the obtained monopolized network function data and send the desensitized monopolized network function data to the second-level NWDAF network element.

11. The method of claim 1, further comprising:
receiving a first request of the NWDAF user; and
based on the first request, determining the second-level NWDAF network element for obtaining the second-level analysis report.

12. The method of claim 11, wherein based on the first request, determining the second-level NWDAF network element for obtaining the second-level analysis report comprises:
based on the first request, obtaining a network element identifier of the second-level NWDAF network element from a unified data management function network element (UDM).

13. The method of claim 11, wherein the first request comprises at least one of:
identifier information of the first-class analysis;
identifier information of the target UE; or
identifier information of a second-class analysis associated with the first-class analysis.

14. The method of claim 12, wherein based on the first request, obtaining the network element identifier of the second-level NWDAF network element from the UDM comprises:
based on the first request, determining, from the UDM, information of a monopolized network function (NF) of the network slice to which the target UE belongs; and
based on the information of the monopolized NF, determining, from the second-level NWDAF network element registered in a network repository function (NRF) network element, a network element identifier of the second-level NWDAF network element serving the network slice to which the target UE belongs.

15. The method of claim 12, further comprising:
based on the network element identifier of the second-level NWDAF network element, sending a second request to the second-level NWDAF network element, wherein the second request is configured for the second-level NWDAF network element to report analysis data.

16. The method of claim 15, wherein the second request comprises at least one of:
identifier information of the first-class analysis;
identifier information of the target UE; or
identifier information of a second-class analysis associated with the first-class analysis.

17. The method of claim 12, wherein the second-level NWDAF network element is further configured to send a third request to an auxiliary NWDAF network element, wherein the third request comprises at least one of:
identifier information of the target UE; or
identifier information of a second-class analysis associated with the first-class analysis.

18. The method of claim 11, wherein the first request is a request sent by the NWDAF user to the a first-level NWDAF network element registered in a network repository function (NRF) network element,
wherein the NRF is configured to receive an analysis request from the NWDAF user, and based on the analysis request, send an analysis request response to the NWDAF user, wherein the analysis request comprises identifier information of the first-class analysis, and the analysis request response is configured for the NWDAF user to determine to send the first request to the first-level NWDAF network element.

19. (canceled)

20. The method of claim 18, wherein the NWDAF network element registered in the NRF network element at least comprise the first-level NWDAF network element and the second-level NWDAF network element.

21. A data analysis method of a radio network, applied to a second-level network data analytics function (NWDAF) network element and comprising:
according to a to-be-performed first-class analysis, sending a second-level analysis report to a first-level NWDAF network element, wherein
the second-level NWDAF network element is in correspondence with a network slice to which a target user equipment (UE) corresponding to the first-class analysis belongs, and
the first-level NWDAF network element is configured to, according to the second-level analysis report, send a first-level analysis report to an NWDAF user, the NWDAF user is configured to adjust network parameters of a first-class analysis based on the first-level analysis report.

22-31. (canceled)

32. A communication device, comprising:
a processor; and
a memory storing instructions executable by the processor,
wherein the processor is configured to, when executing the instructions, perform operations comprising:
according to a to-be-performed first-class analysis, obtaining a second-level analysis report sent by a second-level network data analytics function (NWDAF) network element in correspondence with a network slice to which a target user equipment (UE) belongs; and
according to the second-level analysis report, sending a first-level analysis report to an NWDAF user, wherein the NWDAF user is configured to adjust network parameters of the first-class analysis according to a first-level analysis report.

33. (canceled)

34. A communication device, comprising:
a processor; and
a memory storing instructions executable by the processor,
wherein the processor is configured to, when executing the instructions, perform the data analysis method of the radio network according to claim 21.
